(19) United States
(12) Patent Application Publication
(10) Pub. No.: US 2024/0147059 A1
(43) Pub. Date: May 2, 2024

(54) DOORBELL SYSTEM

(71) Applicant: Primax Electronics Ltd., Taipei (TW)

(72) Inventor: Tsung-Han Li, Taipei (TW)

(21) Appl. No.: 18/098,653

(22) Filed: Jan. 18, 2023

(30) Foreign Application Priority Data
Oct. 28, 2022 (TW) 111141273

(51) Int. Cl. H04N 23/661; G08B 3/10; H04L 12/10

(52) U.S. Cl. CPC H04N 23/661; G08B 3/1016; H04L 12/10

(57) ABSTRACT

A doorbell system includes a chime device, a network communication device and a doorbell body. The chime device is disposed within a first space. The network communication device has a Power over Ethernet function. The network communication device issues an Ethernet network power signal and provides a remote network communication service. The doorbell body includes a doorbell button. The doorbell body is electrically connected with the network communication device through a Power-over-Ethernet power supply and data bus. The doorbell body receives the Ethernet network power signal from the network communication device through the Power-over-Ethernet power supply and data bus. The doorbell body is powered by the Ethernet network power signal only. In response to a pressing and activating action on the doorbell button, the doorbell body issues a doorbell enabling control signal. The chime device generates a chime sound effect in response to the doorbell enabling control signal.

### FIELD OF THE INVENTION

The present invention relates to a doorbell system, and more particularly to a doorbell system with a PoE (Power over Ethernet) function.

### BACKGROUND OF THE INVENTION

Nowadays, the trends of designing doorbell systems in the market are toward the intelligent doorbell systems with remote/proximal audio and video functions and network monitoring functions.

For example, the intelligent doorbell system for home use or enterprise use usually comprises a doorbell body, a wireless communication device and a chime. The doorbell body is located outdoors and equipped with an image capture module and an audio processing module. The wireless communication device and the chime are installed indoors. Moreover, the wireless communication device has a Wi-Fi communication function. The above components are collaboratively formed as the intelligent doorbell system with remote/proximal audio and video functions and network monitoring functions.

However, the design of the intelligent doorbell system still has some drawbacks. For example, for providing requiring electric power to components of the intelligent doorbell system at any time, the power supply of the intelligent doorbell system usually needs to be carried out continuously for 24 hours per day. Consequently, when the doorbell body is not pressed and activated, an AC power supply module connected to the utility power source is usually used as a power source for providing electric power to the image capture module and the audio processing module of the doorbell body. In case that the doorbell body is pressed and activated by a user, the aforementioned AC power supply module provides the electric power to the chime instead. At this moment, the electric power supplied to the image capture module and the audio processing module of the doorbell body cannot be interrupted. Consequently, a built-in battery in the doorbell body provides the electric power to the doorbell body.

Since the doorbell body is installed outdoors, the battery in the doorbell body needs to comply with a certain working requirement. That is, the battery can withstand a certain ambient temperature condition. If the ambient temperature is too low or too high, the battery is possibly unable to be normally operated. In other words, the applications of the conventional doorbell system are limited by the installation location and the use place.

Furthermore, the design of the conventional doorbell system has a more common deficiency. For example, the conventional doorbell system needs to prevent any unexpected current from flowing through the chime when the doorbell body is not pressed and activated. In case that the unexpected current flows through the chime, the generation of the undesired noise (e.g., disturbing tiny buzzing sound) from the chime can be avoided. However, in the conventional doorbell system, the AC power supply module is the shared power source for providing electric power to the doorbell body and the chime. For avoiding the generation of the noise when the doorbell body is not pressed and activated, it is necessary to additionally install a shunt control circuit. The arrangement of the shunt control circuit will not only increase the design cost of the conventional doorbell system, but also increase the instability and complexity of the overall circuit.

In order to achieve the remote network monitoring function and reduce the wiring troubles of additional wired communication transmission lines between the indoor space and the outdoor space, the transmission method between the conventional doorbell body and the conventional wireless communication module usually adopts a Wi-Fi wireless communication technology. That is, the doorbell body (i.e., the component is located outdoors and including the image capture module and the audio processing module) and the wireless communication device (i.e., the component located indoors) are in communication with each other according to the Wi-Fi wireless communication technology. For example, a Wi-Fi wireless communication module is installed in the outdoor doorbell body, and another Wi-Fi wireless communication module is installed in the indoor wireless communication device. Moreover, these two Wi-Fi wireless communication modules are in communication with each other. However, the conventional transmission method still has some drawbacks. For example, the performance of the conventional doorbell system is restricted by the transmission distance limitation of Wi-Fi communication technology, the physical factors of the wireless signals to penetrate through buildings, the anti-interference ability against electromagnetic wave and weather in the outdoor environment, or some other possible factors. Since the conventional doorbell system is usually unable to provide stable signal communication quality, the ability and reliability of the remote network monitoring capability are impaired.

Therefore, it is important to provide an improved doorbell system in order to overcome the drawbacks of the conventional technologies.

### SUMMARY OF THE INVENTION

An object of the present invention provides a doorbell system using a Power-over-Ethernet power supply and data bus as the main transmission path of the power signal and the data/control signal.

Another object of the present invention provides a doorbell system without the need of using a battery as the backup power source of the doorbell body.

A further object of the present invention provides a doorbell system without the need of additionally connecting the chime device with a shunt control circuit or equipping a shut control circuit.

In accordance with an aspect of the present invention, a doorbell system is provided. The doorbell system includes a chime device, a network communication device and a doorbell body. The chime device is disposed within a first space. The network communication device has a Power over Ethernet function. The network communication device is disposed within the first space. The network communication device issues an Ethernet network power signal and provides a remote network communication service. The doorbell body is disposed within a second space. The doorbell body includes a doorbell button. The doorbell body is electrically connected with the network communication device through a Power-over-Ethernet power supply and data bus. The doorbell body receives the Ethernet network power signal from the network communication device through the Power-over-Ethernet power supply and data bus. The doorbell body is powered by the Ethernet network power signal only. In response to a pressing and activating action on the doorbell button, the doorbell body issues a doorbell enabling control signal. The doorbell enabling control signal is directly transmitted to the chime device, or the doorbell enabling control signal is transmitted to the chime device through the Power-over-Ethernet power supply and data bus and the network communication device. The chime device generates a chime sound effect in response to the doorbell enabling control signal.

In an embodiment, the network communication device at least includes a first Power-over-Ethernet power supply and data interface, and the doorbell body at least includes a second Power-over-Ethernet power supply and data interface. The Power-over-Ethernet power supply and data bus is electrically connected between the first Power-over-Ethernet power supply and data interface and the second Power-over-Ethernet power supply and data interface.

In an embodiment, the Power-over-Ethernet power supply and data bus is a wired power supply and data bus complying with a Power over Ethernet protocol. The first space and the second space are separated from each other by a building structure. The Power-over-Ethernet power supply and data bus is penetrated through the building structure. The Power-over-Ethernet power supply and data bus is connected between the first Power-over-Ethernet power supply and data interface and the second Power-over-Ethernet power supply and data interface in a wired connection manner.

In an embodiment, the network communication device further includes a repeater and a network access and control module. The repeater at least includes the first Power-over-Ethernet power supply and data interface and a wireless communication module. The wireless communication module is in wireless communication with the network access and control module.

In an embodiment, the repeater provides the Ethernet network power signal, and the Ethernet network power signal is transmitted to the doorbell body through the first Power-over-Ethernet power supply and data interface, the Power-over-Ethernet power supply and data bus and the second Power-over-Ethernet power supply and data interface sequentially, so that the doorbell body is powered by the Ethernet network power signal only.

In an embodiment, the network access and control module at least includes an access point unit and/or a router control unit.

In an embodiment, the doorbell system further includes a first audio processing module and a second audio processing module, and an audio processing signal is transferred between the first audio processing module and the second audio processing module. The first audio processing module is included in the chime device or the repeater of the network communication device. The second audio processing module is included in the doorbell body.

In an embodiment, the doorbell body further includes a main control module and an image capture module. The image capture module is electrically connected with the main control module. After the image capture module generates an image capture signal to the main control module, the image capture signal is transmitted from the main control module to the network access and control module through the second Power-over-Ethernet power supply and data interface, the Power-over-Ethernet power supply and data bus, the first Power-over-Ethernet power supply and data interface and the wireless communication module sequentially. The remote network communication service is provided by the network access and control module in response to the image capture signal.

In an embodiment, the doorbell body further includes a main control module and a power conversion module. The power conversion module is electrically connected between the main control module and the second Power-over-Ethernet power supply and data interface. After the Ethernet network power signal is received by the second Power-over-Ethernet power supply and data interface, the Ethernet network power signal is processed by the power conversion module and then transmitted to the main control module.

In an embodiment, the chime device is disposed outside the network communication device, and the chime device is powered by a chime power signal independent of the Ethernet network power signal.

In an embodiment, the chime power signal is provided by a chime power source, and the chime power source includes at least one of a DC power supply module and an AC power supply module.

In an embodiment, the doorbell body further includes a main control module, and the doorbell button is electrically connected with the main control module. In response to the pressing and activating action on the doorbell button, the main control module issues the doorbell enabling control signal, and the doorbell enabling control signal is transmitted to the chime device through the Power-over-Ethernet power supply and data bus and the network communication device sequentially, so that the chime device generates the chime sound effect.

In an embodiment, the chime power source includes the AC power supply module, the doorbell body further includes a main control module and an electronic switch, and the electronic switch is electrically connected with the main control module. In response to the pressing and activating action on the doorbell button, the main control module issues the doorbell enabling control signal, and the doorbell enabling control signal is transmitted to the AC power supply module through the electronic switch. In response to the doorbell enabling control signal, the chime power signal is transmitted from the AC power supply module to the chime device, so that the chime device generates the chime sound effect.

In an embodiment, the chime device is disposed within a repeater of the network communication device, and the doorbell body further includes a main control module. The doorbell button is electrically connected with the main control module. In response to the pressing and activating action on the doorbell button, the main control module issues the doorbell enabling control signal, and the doorbell enabling control signal is transmitted to the repeater through the Power-over-Ethernet power supply and data bus, so that the chime device in the repeater generates the chime sound effect.

In accordance with another aspect of the present invention, a doorbell system is provided. The doorbell system includes a chime device, a network communication device and a doorbell body. The chime device is disposed within a first space. The network communication device has a Power over Ethernet function. The network communication device is disposed within the first space. The network communication device issues an Ethernet network power signal and provides a remote network communication service. The doorbell body is disposed within a second space. The doorbell body includes a doorbell button and an image capture module. The doorbell body is electrically connected with the network communication device through a Power-over-Ethernet power supply and data bus. The doorbell body receives the Ethernet network power signal from the network communication device through the Power-over-Ethernet power supply and data bus. The doorbell body is powered by the Ethernet network power signal only. The image capture module issues an image capture signal to the network communication device through the Power-over-Ethernet power supply and data bus. The remote network communication service is provided by the network communication device in response to the image capture signal. The chime device is included in the network communication device or not included in the network communication device. The chime device generates a chime sound effect in response to a doorbell enabling control signal from the doorbell body. If the chime device is not included in the network communication device, the chime device is powered by a chime power signal independent of the Ethernet network power signal.

In an embodiment, the network communication device at least includes a first Power-over-Ethernet power supply and data interface, and the doorbell body at least includes a second Power-over-Ethernet power supply and data interface. The Power-over-Ethernet power supply and data bus is electrically connected between the first Power-over-Ethernet power supply and data interface and the second Power-over-Ethernet power supply and data interface.

In an embodiment, the Power-over-Ethernet power supply and data bus is a wired power supply and data bus complying with a Power over Ethernet protocol. The first space and the second space are separated from each other by a building structure. The Power-over-Ethernet power supply and data bus is penetrated through the building structure. The Power-over-Ethernet power supply and data bus is connected between the first Power-over-Ethernet power supply and data interface and the second Power-over-Ethernet power supply and data interface in a wired connection manner.

In an embodiment, the network communication device further includes a repeater and a network access and control module. The repeater at least includes the first Power-over-Ethernet power supply and data interface and a wireless communication module. The wireless communication module is in wireless communication with the network access and control module.

In an embodiment, the repeater provides the Ethernet network power signal, and the Ethernet network power signal is transmitted to the doorbell body through the first Power-over-Ethernet power supply and data interface, the Power-over-Ethernet power supply and data bus and the second Power-over-Ethernet power supply and data interface sequentially, so that the doorbell body is powered by the Ethernet network power signal only.

In an embodiment, the network access and control module at least includes an access point unit and/or a router control unit.

In an embodiment, the doorbell system further includes a first audio processing module and a second audio processing module, and an audio processing signal is transferred between the first audio processing module and the second audio processing module. The first audio processing module is included in the chime device or the repeater of the network communication device, and the second audio processing module is included in the doorbell body.

In an embodiment, the doorbell body further includes a main control module and an image capture module. The image capture module is electrically connected with the main control module. After the image capture module generates an image capture signal to the main control module, the image capture signal is transmitted from the main control module to the network access and control module through the second Power-over-Ethernet power supply and data interface, the Power-over-Ethernet power supply and data bus, the first Power-over-Ethernet power supply and data interface and the wireless communication module sequentially. The remote network communication service is provided by the network access and control module in response to the image capture signal.

In an embodiment, the doorbell body further includes a main control module and a power conversion module. The power conversion module is electrically connected between the main control module and the second Power-over-Ethernet power supply and data interface. After the Ethernet network power signal is received by the second Power-over-Ethernet power supply and data interface, the Ethernet network power signal is processed by the power conversion module and then transmitted to the main control module.

In an embodiment, the chime power signal is provided by a chime power source, and the chime power source includes at least one of a DC power supply module and an AC power supply module.

In an embodiment, the doorbell body further includes a main control module, and the doorbell button is electrically connected with the main control module. In response to the pressing and activating action on the doorbell button, the main control module issues the doorbell enabling control signal, and the doorbell enabling control signal is transmitted to the chime device through the Power-over-Ethernet power supply and data bus and the network communication device sequentially, so that the chime device generates the chime sound effect.

In an embodiment, the chime power source includes the AC power supply module, the doorbell body further includes a main control module and an electronic switch, and the electronic switch is electrically connected with the main control module. In response to the pressing and activating action on the doorbell button, the main control module issues the doorbell enabling control signal, and the doorbell enabling control signal is transmitted to the AC power supply module through the electronic switch. In response to the doorbell enabling control signal, the chime power signal is transmitted from the AC power supply module to the chime device, so that chime device generates the chime sound effect.

In an embodiment, the chime device is disposed within a repeater of the network communication device, and the doorbell body further includes a main control module, and the doorbell button is electrically connected with the main control module. In response to the pressing and activating action on the doorbell button, the main control module issues the doorbell enabling control signal, and the doorbell enabling control signal is transmitted to the repeater through the Power-over-Ethernet power supply and data bus, so that the chime device in the repeater generates the chime sound effect.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic functional block diagram illustrating the architecture of a doorbell system according to a first embodiment of the present invention;

FIG. 2 is a schematic functional block diagram illustrating the architecture of a doorbell system according to a second embodiment of the present invention; and

FIG. 3 is a schematic functional block diagram illustrating the architecture of a doorbell system according to a third embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. In the following embodiments and drawings, the elements irrelevant to the concepts of the present invention are omitted and not shown.

In order to overcome the drawbacks of the conventional technologies, the present invention provides a doorbell system. The doorbell system uses a Power-over-Ethernet power supply and data bus as the main transmission path of the power signal and the data/control signal. Especially, it is not necessary to additionally install a battery or a shunt control circuit. Hereinafter, some embodiments will be provided to illustrate the technical concepts of the present invention. It is noted that the embodiments are not restricted.

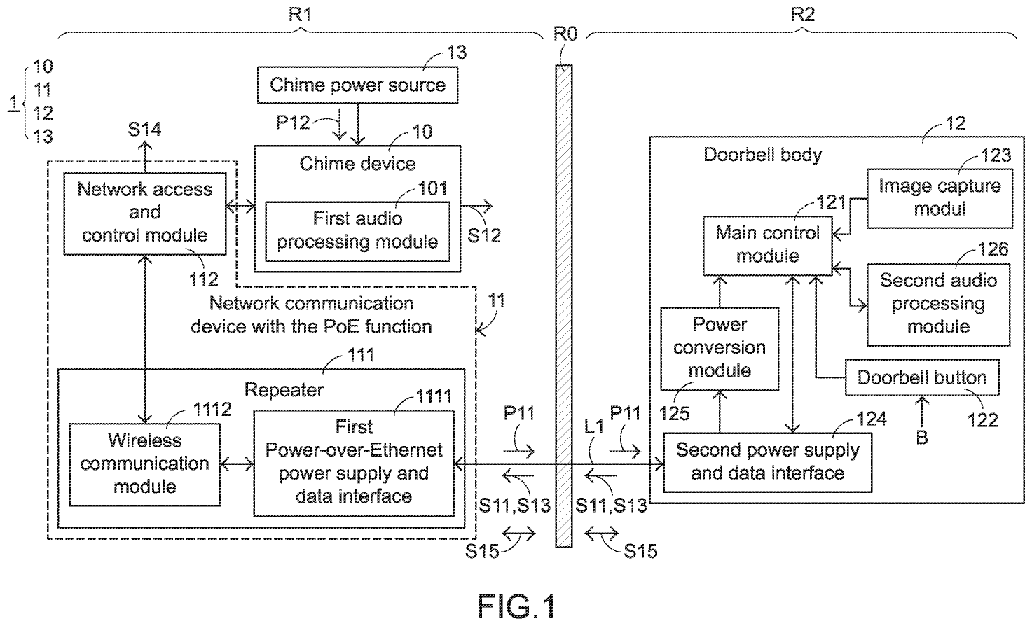

FIG. 1 is a schematic functional block diagram illustrating the architecture of a doorbell system according to a first embodiment of the present invention. In this embodiment, the doorbell system 1 at least comprises a chime device 10, a network communication device 11 and a doorbell body 12. The chime device 10 is disposed within a first space R1. The network communication device 11 is also disposed within a first space R1. In addition, the network communication device 11 has a Power over Ethernet (PoE) function. The doorbell body 12 is disposed within a second space R2. In addition, the doorbell body 12 comprises a doorbell button 122.

In an embodiment, the first space R1 and the second space R2 are respectively an indoor space and an outdoor space that are separated from each other by a building structure R0. In some other embodiments, the first space R1 and the second space R2 are two individual spaces in an inner space or an outer space.

The network communication device 11 and the doorbell body 12 are electrically connected with each other through a Power-over-Ethernet power supply and data bus L1. For brevity, the Power-over-Ethernet power supply and data bus L1 is also referred as a power supply and data bus L1. The doorbell body 12 can receive an Ethernet network power signal P11 from the network communication device 11 through the power supply and data bus L1.

In an embodiment, the network communication device 11 at least comprises a repeater 111 and a network access and control module 112. The repeater 111 at least comprises a first Power-over-Ethernet power supply and data interface 1111 and a wireless communication module 1112. For brevity, the first Power-over-Ethernet power supply and data interface 1111 is also referred as a first power supply and data interface. The wireless communication module 1112 is in wireless communication with the network access and control module 112. For example, the wireless communication module 1112 is a Wi-Fi wireless communication module.

The power supply and data bus L1 is a wired power supply and data bus complying with the PoE protocol. The power supply and data bus L1 is penetrated through the building structure R0 that is used for separating the first space R1 from the second space R2. In addition, power supply and data bus L1 is connected between first power supply and data interface 111 and a second Power-over-Ethernet power supply and data interface 124 in the doorbell body 12 in a wired connection manner. For brevity, the second Power-over-Ethernet power supply and data interface 124 is also referred as a second power supply and data interface.

The repeater 111 is served as a power source for generating the Ethernet network power signal P11. The repeater 111 can provide the Ethernet network power signal P11 to the doorbell body 12 through the power supply and data bus L1. Especially, the Ethernet network power signal P11 is the only supplied power for the doorbell body 12.

The implementation examples of the network access and control module 112 are not restricted. Preferably but not exclusively, the network access and control module 112 comprises an access point (AP) unit (not shown) and/or a router control unit (not shown).

In an embodiment, the chime device 10 is located outside the network communication device 11. Moreover, the chime device 10 is electrically connected with the network access and control module 112 of the network communication device 11. In addition, the chime device 10 is powered by a chime power signal P12, which is independent of the Ethernet network power signal P11.

In an embodiment, the chime power signal P12 is supplied by a chime power source 13. The chime power source 13 may be selected according to the circuitry structure of the chime device 10. For example, in case that the chime device 10 has the DC circuitry structure, the chime power source 13 is a DC power supply module. Moreover, in case that the chime device 10 has the AC circuitry structure, the chime power source 13 is an AC power supply module.

Especially, the chime power signal P12 is provided to power the chime device 10 only. That is, the chime power signal P12 is not provided to the doorbell body 12. Since the chime power signal P12 is not shared by the chime device 10 and the doorbell body 12, it is not necessary to additionally install a shunt control circuit in the chime device 10.

Preferably but not exclusively, the chime device 10 further comprises another wireless communication module (not shown). The wireless communication module of the chime device 10 is in wireless communication with the network access and control module 112.

The doorbell system 1 further comprises a first audio processing module 101. In this embodiment, the first audio processing module 101 is disposed within the chime device 10.

In an implementation example, the first audio processing module 101 comprises a microphone and/or a speaker. Due to the arrangement of the first audio processing module 101, the voice communication between a first user (not shown) in the first space R1 and a second user (not shown) in the second space R2 can be performed.

In an embodiment, the doorbell body 12 at least comprises a main control module 121, the doorbell button 122, an image capture module 123, the second power supply and data interface 124, a power conversion module 125 and a second audio processing module 126. The doorbell button 122 and the image capture module 123 are electrically connected with the main control module 121. The power conversion module 125 is electrically connected between the main control module 121 and the second power supply and data interface 124.

The operations of the doorbell system 1 will be described as follows.

Firstly, the second user performs a pressing and activating action B on the doorbell button 122. In response to the pressing and activating action B, the main control module 121 issues a doorbell enabling control signal S11. The doorbell enabling control signal S11 is transmitted to the chime device 10 through the power supply and data bus L1 and the network communication device 11 sequentially. In response to the doorbell enabling control signal S11, the chime device 10 generates a chime sound effect S12.

The image capture module 123 (e.g., a video camera) generates an image capture signal S13 to the main control module 121. The image capture signal S13 is transmitted from the main control module 121 to the network access and control module 112 through the second power supply and data interface 124, the power supply and data bus L1, the first power supply and data interface 1111 and the wireless communication module 1112 sequentially. Consequently, a remote network communication service S14 is provided by the doorbell system 1 through the network access and control module 112, and the remote network communication service S14 is implemented through a mobile phone or a computer of the remote user.

Preferably but not exclusively, the remote network communication service S14 at least includes a remote audio and video function and/or a network monitoring function.

In an implementation example, the second audio processing module 126 in the doorbell body 12 comprises a microphone and/or a speaker. The second audio processing module 126 and the first audio processing module 101 cooperate with each other to transfer an audio processing signal S15. That is, the audio processing signal S15 is transmitted between the second audio processing module 126 and the first audio processing module 101. Consequently, the voice communication between the first user in the first space R1 and the second user in the second space R2 can be performed.

As mentioned above, the power conversion module 125 is electrically connected between the main control module 121 and the second power supply and data interface 124. After the Ethernet network power signal P11 is received by the second power supply and data interface 124, the Ethernet network power signal P11 is converted into at last one power signal by the power conversion module 125. The power signals with regulated voltage levels are transmitted to the main control module 121. For example, the Ethernet network power signal P11 outputted from the second power supply and data interface 124 has a single voltage level. By the power conversion module 125, the Ethernet network power signal P11 is converted into power signals with plural different voltage levels (e.g., 48V, 12V and 5V). The power signals are provided to the main control module 121 so as to be used by the main control module 121.

It is noted that numerous modifications and alterations may be made while retaining the teachings of the invention. For example, in some other embodiments, the power conversion function of the power conversion module 125 is integrated into the second power supply and data interface 124 according to the practical requirements. Under this circumstance, the power conversion module 125 may be omitted.

In the first embodiment of FIG. 1, the power supply and data bus L1 is served as the main transmission path for transmitting the power signal (e.g., the Ethernet network power signal P11) and the data/control signals (e.g., the image capture signal S13, the audio processing signal S15 or the doorbell enabling control signal S11). Due to the special design of the doorbell system 1, it is not necessary to install the built-in battery in the doorbell body 12, and it is not necessary to additionally install a shunt control circuit in the chime device 10. Moreover, the doorbell system 1 can provide stable communication quality.

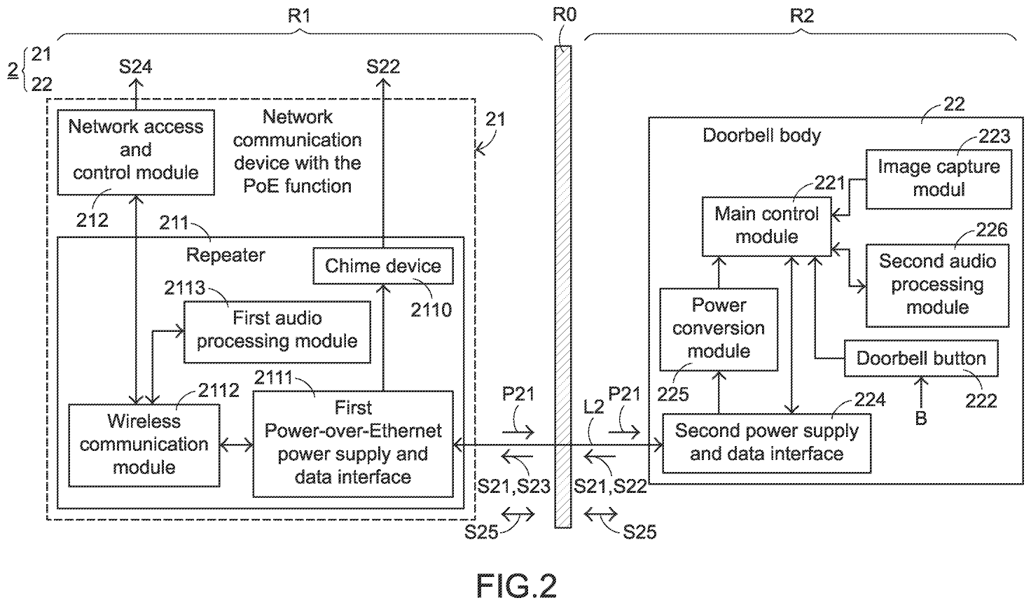

FIG. 2 is a schematic functional block diagram illustrating the architecture of a doorbell system according to a second embodiment of the present invention. In this embodiment, the doorbell system 2 at least comprises a network communication device 21 and a doorbell body 22. The network communication device 21 is disposed within a first space R1. In addition, the network communication device 21 has a Power over Ethernet (PoE) function. The doorbell body 22 is disposed within a second space R2. In addition, the doorbell body 22 comprises a doorbell button 222.

The network communication device 21 and the doorbell body 22 are electrically connected with each other through a Power-over-Ethernet power supply and data bus L2. For brevity, the Power-over-Ethernet power supply and data bus L2 is also referred as a power supply and data bus L2. The doorbell body 22 can receive an Ethernet network power signal P21 from the network communication device 21 through the power supply and data bus L2.

In an embodiment, the network communication device 21 at least comprises a repeater 211 and a network access and control module 212. The repeater 211 at least comprises a first Power-over-Ethernet power supply and data interface 2111 and a wireless communication module 2112. For brevity, the first Power-over-Ethernet power supply and data interface 2111 is also referred as a first power supply and data interface 2111. The wireless communication module 2112 is in wireless communication with the network access and control module 212.

Moreover, the doorbell body 22 at least comprises a second Power-over-Ethernet power supply and data interface 224. For brevity, the second Power-over-Ethernet power supply and data interface 224 is also referred as a second power supply and data interface 224. The power supply and data bus L2 is electrically connected between the first power supply and data interface 2111 and the second power supply and data interface 224.

The repeater 211 is served as a power source for generating the Ethernet network power signal P21. The repeater 211 can provide the Ethernet network power signal P21 to the doorbell body 22 through the power supply and data bus L2. Especially, the Ethernet network power signal P21 is the only supplied power for the doorbell body 22.

The technical concepts of the doorbell system in the second embodiment and shown in FIG. 2 are similar to those of the doorbell system in the first embodiment and shown in FIG. 1. For example, the structure and function of the network access and control module 212 are similar to those of the network access and control module 112. In comparison with the first embodiment, the network communication device 21 in the doorbell system 2 of this embodiment is equipped with a chime device 2110. For example, the chime device 2110 is included in the repeater 211 of the chime device 2110. Moreover, the doorbell system 2 further comprises a first audio processing module 2113. The first audio processing module 2113 is also included in the repeater 211.

In an embodiment, the doorbell body 22 at least comprises a main control module 221, the doorbell button 222, an image capture module 223, the second power supply and data interface 224, a power conversion module 225 and a second audio processing module 226. The doorbell button 222 and the image capture module 223 are electrically connected with the main control module 221. The power conversion module 225 is electrically connected between the main control module 221 and the second power supply and data interface 224.

After a pressing and activating action B on the doorbell button 222 is performed, the main control module 221 issues a doorbell enabling control signal S21 in response to the pressing and activating action B. The doorbell enabling control signal S21 is transmitted to the repeater 211 through the power supply and data bus L2. In response to the doorbell enabling control signal S21, the chime device 2110 in the repeater 211 generates a chime sound effect S22.

The image capture module 223 (e.g., a video camera) generates an image capture signal S23 to the main control module 221. The image capture signal S23 is transmitted from the main control module 221 to the network access and control module 212 through the second power supply and data interface 224, the power supply and data bus L2, the first power supply and data interface 2111 and the wireless communication module 2112 sequentially. Consequently, a remote network communication service S24 is provided by the doorbell system 2 through the network access and control module 212, and the remote network communication service S24 is implemented through a mobile phone or a computer of the remote user.

In an implementation example, the second audio processing module 226 in the doorbell body 22 comprises a microphone and/or a speaker. The second audio processing module 226 and the first audio processing module 2113 cooperate with each other to transfer an audio processing signal S25. That is, the audio processing signal S25 is transmitted between the second audio processing module 226 and the first audio processing module 2113. Consequently, the voice communication between a first user (not shown) in the first space R1 and a second user (not shown) in the second space R2 can be performed.

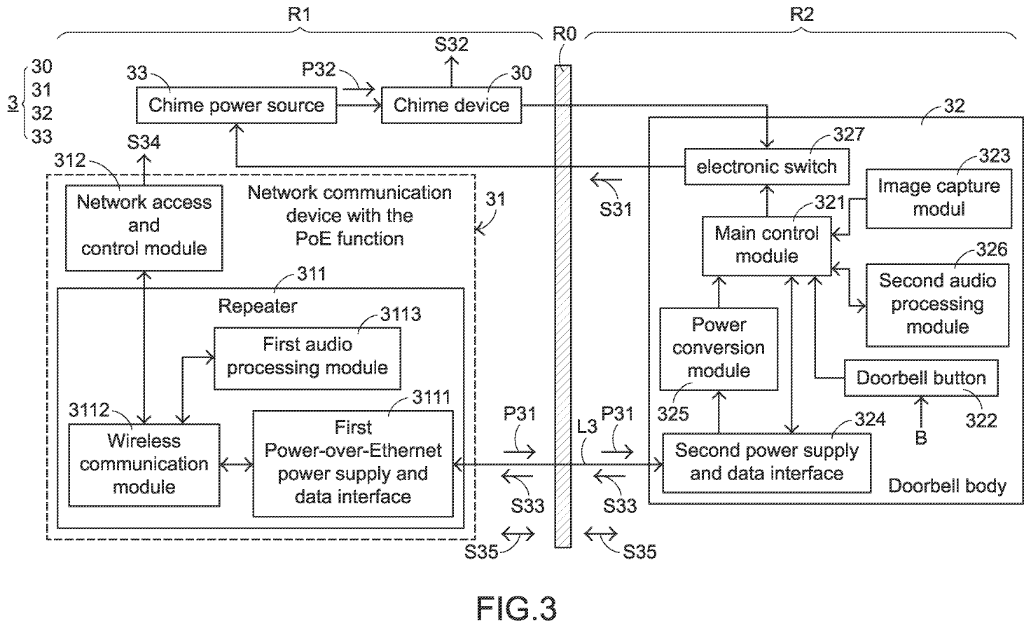

FIG. 3 is a schematic functional block diagram illustrating the architecture of a doorbell system according to a third embodiment of the present invention. In this embodiment, the doorbell system 3 at least comprises a chime device 30, a network communication device 31 and a doorbell body 32. The network communication device 31 is disposed within a first space R1. In addition, the network communication device 31 has a Power over Ethernet (PoE) function. The doorbell body 32 is disposed within a second space R2. In addition, the doorbell body 32 comprises a doorbell button 322.

The network communication device 31 and the doorbell body 32 are electrically connected with each other through a Power-over-Ethernet power supply and data bus L3. For brevity, the Power-over-Ethernet power supply and data bus L3 is also referred as a power supply and data bus L3. The doorbell body 32 can receive an Ethernet network power signal P31 from the network communication device 31 through the power supply and data bus L3.

In an embodiment, the network communication device 31 at least comprises a repeater 311 and a network access and control module 312. The repeater 311 at least comprises a first Power-over-Ethernet power supply and data interface 3111 and a wireless communication module 3112. For brevity, the first Power-over-Ethernet power supply and data interface 3111 is also referred as a first power supply and data interface 3111. The wireless communication module 3112 is in wireless communication with the network access and control module 312.

The repeater 311 is served as a power source for generating the Ethernet network power signal P31. The repeater 311 can provide the Ethernet network power signal P31 to the doorbell body 32 through the power supply and data bus L3. Especially, the Ethernet network power signal P31 is the only supplied power for the doorbell body 32.

In an embodiment, the chime device 30 is located outside the network communication device 31. In addition, the chime device 30 is powered by a chime power signal P32, which is independent of the Ethernet network power signal P31.

In an embodiment, the chime power signal P32 is supplied by a chime power source 33. The chime power source 33 may be selected according to the circuitry structure of the chime device 30. For example, in case that the chime device 30 has the DC circuitry structure, the chime power source 33 is a DC power supply module. Moreover, in case that the chime device 30 has the AC circuitry structure, the chime power source 33 is an AC power supply module.

Especially, the chime power signal P32 is provided to power the chime device 30 only. That is, the chime power signal P32 is not provided to the doorbell body 32. Since the chime power signal P32 is not shared by the chime device 30 and the doorbell body 32, it is not necessary to additionally install a shunt control circuit in the chime device 30.

The technical concepts of the doorbell system in the third embodiment and shown in FIG. 3 are similar to those of the doorbell system in the first embodiment and shown in FIG. 1. For example, the structure and function of the network access and control module 312 are similar to those of the network access and control module 112. In comparison with the first embodiment, the chime device 30 in the doorbell system 3 of this embodiment is not electrically connected with the network communication device 31. Similarly, the source of the power signal for the chime device 30 and the source of the power signal for the doorbell body 32 are independent of each other. However, the on/off states of the power source for the chime device 30 can be controlled under the doorbell body 32. In other words, the technical concepts about the power supply for the chime device in the doorbell system of this embodiment are based on the modification and the improvement of the conventional doorbell system. Consequently, the operating drawbacks of the conventional doorbell system are overcome, and the operating stability of the doorbell system is largely enhanced.

Similarly, the doorbell body 32 at least comprises a main control module 321, the doorbell button 322, an image capture module 323, the second power supply and data interface 324, a power conversion module 325 and a second audio processing module 326. The doorbell button 322 and the image capture module 323 are electrically connected with the main control module 321. The power conversion module 325 is electrically connected between the main control module 321 and the second power supply and data interface 324.

In comparison with the above embodiment, the doorbell body 32 in the doorbell system 3 of this embodiment further comprises a an electronic switch 327. The electronic switch 327 is electrically connected with the main control module 321. In response to a pressing and activating action B on the doorbell button 322, the main control module 321 issues a doorbell enabling control signal S31. The doorbell enabling control signal S31 is transmitted from the main control module 321 to the chime power source 33 (e.g., an AC power supply module) through the electronic switch 327. In response to the doorbell enabling control signal S31, the chime power source 33 provides the chime power source P32 to the chime device 30. In response to the chime power source P32, the chime device 30 generates a chime sound effect S32.

The image capture module 323 (e.g., a video camera) generates an image capture signal S33 to the main control module 321. The image capture signal S33 is transmitted from the main control module 321 to the network access and control module 312 through the second power supply and data interface 324, the power supply and data bus L3, the first power supply and data interface 3111 and the wireless communication module 3112 sequentially. Consequently, a remote network communication service S34 is provided by the doorbell system 1 through the network access and control module 112, and the remote network communication service S34 is implemented through a mobile phone or a computer of the remote user.

The doorbell system 3 further comprises a first audio processing module 3113. The implementation of the first audio processing module 3113 is similar to the implementation of the first audio processing module 2113 as shown in FIG. 2 but is distinguished from the implementation of the first audio processing module 101 as shown in FIG. 1. That is, as shown in FIG. 3, the first audio processing module 3113 of the doorbell system 3 in this embodiment is disposed within the repeater 311.

Moreover, the second audio processing module 326 in the doorbell body 32 comprises a microphone and/or a speaker. The second audio processing module 326 and the first audio processing module 3113 cooperate with each other to transfer an audio processing signal S35. That is, the audio processing signal S35 is transmitted between the second audio processing module 326 and the first audio processing module 3113. Consequently, the voice communication between a first user (not shown) in the first space R1 and a second user (not shown) in the second space R2 can be performed.

From the above descriptions, the present invention provides a doorbell system with a PoE (Power over Ethernet) function. The doorbell system uses the Power-over-Ethernet power supply and data bus as the main transmission path of the power signal and the data/control signal. Consequently, the doorbell system does not need to be additionally equipped with a battery and a shut control circuit. In other words, the technologies of the present invention are industrially valuable.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A doorbell system, comprising:
a chime device disposed within a first space;
a network communication device having a Power over Ethernet function, and disposed within the first space, wherein the network communication device issues an Ethernet network power signal and provides a remote network communication service; and
a doorbell body disposed within a second space, and comprising a doorbell button, wherein the doorbell body is electrically connected with the network communication device through a Power-over-Ethernet power supply and data bus, the doorbell body receives the Ethernet network power signal from the network communication device through the Power-over-Ethernet power supply and data bus, and the doorbell body is powered by the Ethernet network power signal only,
wherein in response to a pressing and activating action on the doorbell button, the doorbell body issues a doorbell enabling control signal, wherein the doorbell enabling control signal is directly transmitted to the chime device, or the doorbell enabling control signal is transmitted to the chime device through the Power-over-Ethernet power supply and data bus and the network communication device, wherein the chime device generates a chime sound effect in response to the doorbell enabling control signal.

2. The doorbell system according to claim 1, wherein the network communication device at least comprises a first Power-over-Ethernet power supply and data interface, and the doorbell body at least comprises a second Power-over-Ethernet power supply and data interface, wherein the Power-over-Ethernet power supply and data bus is electrically connected between the first Power-over-Ethernet power supply and data interface and the second Power-over-Ethernet power supply and data interface.

3. The doorbell system according to claim 2, wherein the Power-over-Ethernet power supply and data bus is a wired power supply and data bus complying with a Power over Ethernet protocol, wherein the first space and the second space are separated from each other by a building structure, and the Power-over-Ethernet power supply and data bus is penetrated through the building structure, wherein the Power-over-Ethernet power supply and data bus is connected between the first Power-over-Ethernet power supply and data interface and the second Power-over-Ethernet power supply and data interface in a wired connection manner.

4. The doorbell system according to claim 2, wherein the network communication device further comprises a repeater and a network access and control module, wherein the repeater at least comprises the first Power-over-Ethernet power supply and data interface and a wireless communication module, and the wireless communication module is in wireless communication with the network access and control module.

5. The doorbell system according to claim 4, wherein the repeater provides the Ethernet network power signal, and the Ethernet network power signal is transmitted to the doorbell body through the first Power-over-Ethernet power supply and data interface, the Power-over-Ethernet power supply and data bus and the second Power-over-Ethernet power supply and data interface sequentially, so that the doorbell body is powered by the Ethernet network power signal only.

6. The doorbell system according to claim 4, wherein the network access and control module at least comprises an access point unit and/or a router control unit.

7. The doorbell system according to claim 4, wherein the doorbell system further comprises a first audio processing module and a second audio processing module, and an audio processing signal is transferred between the first audio processing module and the second audio processing module, wherein the first audio processing module is included in the chime device or the repeater of the network communication device, and the second audio processing module is included in the doorbell body.

8. The doorbell system according to claim 4, wherein the doorbell body further comprises a main control module and an image capture module, and the image capture module is electrically connected with the main control module, wherein after the image capture module generates an image capture signal to the main control module, the image capture signal is transmitted from the main control module to the network access and control module through the second Power-over-Ethernet power supply and data interface, the Power-over-Ethernet power supply and data bus, the first Power-over-Ethernet power supply and data interface and the wireless communication module sequentially, wherein the remote network communication service is provided by the network access and control module in response to the image capture signal.

9. The doorbell system according to claim 2, wherein the doorbell body further comprises a main control module and a power conversion module, and the power conversion module is electrically connected between the main control module and the second Power-over-Ethernet power supply and data interface, wherein after the Ethernet network power signal is received by the second Power-over-Ethernet power supply and data interface, the Ethernet network power signal is processed by the power conversion module and then transmitted to the main control module.

10. The doorbell system according to claim 1, wherein the chime device is disposed outside the network communication device, and the chime device is powered by a chime power signal independent of the Ethernet network power signal.

11. The doorbell system according to claim 10, wherein the chime power signal is provided by a chime power source, and the chime power source includes at least one of a DC power supply module and an AC power supply module.

12. The doorbell system according to claim 11, wherein the doorbell body further comprises a main control module, and the doorbell button electrically connected with the main control module, wherein in response to the pressing and activating action on the doorbell button, the main control module issues the doorbell enabling control signal, and the doorbell enabling control signal is transmitted to the chime device through the Power-over-Ethernet power supply and data bus and the network communication device sequentially, so that the chime device generates the chime sound effect.

13. The doorbell system according to claim 11, wherein the chime power source includes the AC power supply module, the doorbell body further comprises a main control module and an electronic switch, and the electronic switch is electrically connected with the main control module, wherein in response to the pressing and activating action on the doorbell button, the main control module issues the doorbell enabling control signal, and the doorbell enabling control signal is transmitted to the AC power supply module through the electronic switch, wherein in response to the doorbell enabling control signal, the chime power signal is transmitted from the AC power supply module to the chime device, so that the chime device generates the chime sound effect.

14. The doorbell system according to claim 1, wherein the chime device is disposed within a repeater of the network communication device, the doorbell body further comprises a main control module, and the doorbell button is electrically connected with the main control module, wherein in response to the pressing and activating action on the doorbell button, the main control module issues the doorbell enabling control signal, and the doorbell enabling control signal is transmitted to the repeater through the Power-over-Ethernet power supply and data bus, so that the chime device in the repeater generates the chime sound effect.

15. A doorbell system, comprising:
a chime device disposed within a first space;
a network communication device having a Power over Ethernet function, and disposed within the first space, wherein the network communication device issues an Ethernet network power signal and provides a remote network communication service; and
a doorbell body disposed within a second space, and comprising a doorbell button and an image capture module, wherein the doorbell body is electrically connected with the network communication device through a Power-over-Ethernet power supply and data bus, the doorbell body receives the Ethernet network power signal from the network communication device through the Power-over-Ethernet power supply and data bus, and the doorbell body is powered by the Ethernet network power signal only, wherein the image capture module issues an image capture signal to the network communication device through the Power-over-Ethernet power supply and data bus, and the remote network communication service is provided by the network communication device in response to the image capture signal,
wherein the chime device is included in the network communication device or not included in the network communication device, wherein the chime device generates a chime sound effect in response to a doorbell enabling control signal from the doorbell body, wherein if the chime device is not included in the network communication device, the chime device is powered by a chime power signal independent of the Ethernet network power signal.

16. The doorbell system according to claim 15, wherein the network communication device at least comprises a first Power-over-Ethernet power supply and data interface, and the doorbell body at least comprises a second Power-over-Ethernet power supply and data interface, wherein the Power-over-Ethernet power supply and data bus is electrically connected between the first Power-over-Ethernet power supply and data interface and the second Power-over-Ethernet power supply and data interface.

17. The doorbell system according to claim 16, wherein the Power-over-Ethernet power supply and data bus is a wired power supply and data bus complying with a Power over Ethernet protocol, wherein the first space and the second space are separated from each other by a building structure, and the Power-over-Ethernet power supply and data bus is penetrated through the building structure, wherein the Power-over-Ethernet power supply and data bus is connected between the first Power-over-Ethernet power supply and data interface and the second Power-over-Ethernet power supply and data interface in a wired connection manner.

18. The doorbell system according to claim 16, wherein the network communication device further comprises a repeater and a network access and control module, wherein the repeater at least comprises the first Power-over-Ethernet power supply and data interface and a wireless communication module, and the wireless communication module is in wireless communication with the network access and control module.

19. The doorbell system according to claim 18, wherein the repeater provides the Ethernet network power signal, and the Ethernet network power signal is transmitted to the doorbell body through the first Power-over-Ethernet power supply and data interface, the Power-over-Ethernet power supply and data bus and the second Power-over-Ethernet power supply and data interface sequentially, so that the doorbell body is powered by the Ethernet network power signal only.

20. The doorbell system according to claim 18, wherein the network access and control module at least comprises an access point unit and/or a router control unit.

21. The doorbell system according to claim 18, wherein the doorbell system further comprises a first audio processing module and a second audio processing module, and an audio processing signal is transferred between the first audio processing module and the second audio processing module, wherein the first audio processing module is included in the chime device or the repeater of the network communication device, and the second audio processing module is included in the doorbell body.

22. The doorbell system according to claim 18, wherein the doorbell body further comprises a main control module and an image capture module, and the image capture module is electrically connected with the main control module, wherein after the image capture module generates an image capture signal to the main control module, the image capture signal is transmitted from the main control module to the network access and control module through the second Power-over-Ethernet power supply and data interface, the Power-over-Ethernet power supply and data bus, the first Power-over-Ethernet power supply and data interface and the wireless communication module sequentially, wherein the remote network communication service is provided by the network access and control module in response to the image capture signal.

23. The doorbell system according to claim 16, wherein the doorbell body further comprises a main control module and a power conversion module, and the power conversion module is electrically connected between the main control module and the second Power-over-Ethernet power supply and data interface, wherein after the Ethernet network power signal is received by the second Power-over-Ethernet power supply and data interface, the Ethernet network power signal is processed by the power conversion module and then transmitted to the main control module.

24. The doorbell system according to claim 15, wherein the chime power signal is provided by a chime power source, and the chime power source includes at least one of a DC power supply module and an AC power supply module.

25. The doorbell system according to claim 24, wherein the doorbell body further comprises a main control module, and the doorbell button is electrically connected with the main control module, wherein in response to the pressing and activating action on the doorbell button, the main control module issues the doorbell enabling control signal, and the doorbell enabling control signal is transmitted to the chime device through the Power-over-Ethernet power supply and data bus and the network communication device sequentially, so that the chime device generates the chime sound effect.

26. The doorbell system according to claim 24, wherein the chime power source includes the AC power supply module, the doorbell body further comprises a main control module and an electronic switch, and the electronic switch is electrically connected with the main control module, wherein in response to the pressing and activating action on the doorbell button, the main control module issues the doorbell enabling control signal, and the doorbell enabling control signal is transmitted to the AC power supply module through the electronic switch, wherein in response to the doorbell enabling control signal, the chime power signal is transmitted from the AC power supply module to the chime device, so that chime device generates the chime sound effect.

27. The doorbell system according to claim 15, wherein the chime device is disposed within a repeater of the network communication device, the doorbell body further comprises a main control module, and the doorbell button is electrically connected with the main control module, wherein in response to the pressing and activating action on the doorbell button, the main control module issues the doorbell enabling control signal, and the doorbell enabling control signal is transmitted to the repeater through the Power-over-Ethernet power supply and data bus, so that the chime device in the repeater generates the chime sound effect.
